(19) United States
(12) Patent Application Publication
(10) Pub. No.: US 2016/0351217 A1
(43) Pub. Date: Dec. 1, 2016

(54) HARD DISK DRIVE CRASH STOP

(71) Applicant: Parker-Hannifin Corporation, Cleveland, OH (US)

(72) Inventors: Stephen G. Armstrong, Pleasant View, UT (US); Kevin A. Paulson, Salt Lake City, UT (US)

(21) Appl. No.: 15/165,385

(22) Filed: May 26, 2016

Related U.S. Application Data
(60) Provisional application No. 62/168,138, filed on May 29, 2015.

(51) Int. Cl. G11B 5/54

(52) U.S. Cl. CPC G11B 5/54

(57) ABSTRACT

A crash stop for an actuator arm of a hard disk drive includes a support body having a cylindrical form and a central axis; and a cantilever element joined at a proximal portion to the support body and having a distal portion spaced apart from the support body to allow for deflection of the distal portion of the cantilever element or the support body relative to the other.

### RELATED APPLICATION

This application claims priority under 35 U.S.C. §119 (e) to U.S. Provisional Patent Application No. 62/168,138 filed on May 29, 2015. The entire disclosure of this provisional application is hereby incorporated by reference.

### TECHNICAL FIELD

The present invention relates generally to the field of disk drive data storage devices, and more particularly, to crash stops for limiting the movement of an actuator of the disk drives.

### BACKGROUND

Hard disk drives are often used in electronic devices to record data onto or to reproduce data from recording media, which can be a disk having one or more recording surfaces. The hard disk drive also often includes a read/write head for reading the data on a recording surface of the disk and for writing data onto one of the surfaces. An actuator is provided for moving the read/write head over a desired location, or track of the disk.

The hard disk drive includes a spindle motor for rotating the disk during operation. When the disk drive is operated, and the actuator moves the head over the disk, the head is floated a predetermined height above the recording surface of the disk while the disk is rotated, and the head detects and/or modifies the recording surface of the disk to retrieve, record, and/or reproduce data from and/or onto the disk.

When the hard disk drive is not in operation, or when the disk is not rotating, the head can be rotated by the actuator to a position such that the head is not over the disk or the recording surfaces. In this non-operational configuration, the head is parked off of the recording surface of the disk.

As disk drives continue to decrease in size, smaller heads, thinner substrates, longer and thinner actuator arms and thinner gimbal assemblies continue to be incorporated into the disk drives. Faster seek times also demand increased velocity of the actuator assembly. These factors increase the need to protect the disk drives from incidental contact between the actuator arm or gimbal assemblies and the disk surfaces. It is therefore necessary to precisely control the extent of actuator travel relative to the non-data zones. Otherwise, an actuator that travels beyond the desired extent or radial travel likely results in damage to the read/write head.

### SUMMARY

In an aspect of the invention there is provided a crash stop for an actuator arm of a hard disk drive that includes a support body having a cylindrical form and a central axis; and a cantilever element joined at a proximal portion to the support body and having a distal portion spaced apart from the support body to allow for deflection of the distal portion of the cantilever element or the support body relative to the other.

In one embodiment, the cantilever element is a skirt. The support body may terminate at the proximate portion of the skirt. Alternatively, the support body may terminate at the distal portion of the skirt.

In one embodiment, the cantilever element includes a first upwardly facing skirt and a second downwardly facing skirt, a first end of the support body terminating at the distal portion of the first skirt and an opposing end of the support body terminating at the distal portion of the second skirt.

In one embodiment, the cantilever element includes a flange joined at a proximate portion to an inner surface of the support body and radiating inwardly toward the central axis of the support body.

In one embodiment, the cantilever element includes a segmented flange joined at a proximate portion to an outer surface of the support body and radiating outwardly from the support body. The flange may be a first unitary flange, with the crash stop further including a second segmented flange joined at a proximate portion to an outer surface of the support body and radiating outwardly from the support body.

In one embodiment, the cantilever element includes a plurality of flanges that spiral outwardly from the support body and overlap an adjacent flange.

The crash stop may include a central bore for receiving a fastener for attaching the crash stop to an external member, such as a chassis.

The crash stop may further include a resilient member interposed between the cantilever element and the support body. In one embodiment, the resilient member is an O-ring.

In one aspect of the invention there is provided a hard disk drive that includes: a disk with a data surface of concentric tracks; a spindle motor for rotating the disk about an axis generally perpendicular to the disk; a slider maintained in operative relationship with the data surface when the disk is rotating; a transducer attached to the slider for reading data from and writing data to the data surface; an actuator for moving the slider generally radially relative to the disk to allow the transducer to access the data tracks; and at least one crash stop for limiting movement of the actuator, wherein the crash stop includes a support body having a cylindrical form and a central axis; and a cantilever element joined at a proximal portion to the support body and having a distal portion spaced apart from the support body to allow for deflection of the distal portion of the cantilever element or the support body relative to the other.

### BRIEF DESCRIPTION OF THE DRAWINGS

Embodiments of this invention will now be described in further detail with reference to the accompanying drawings, in which:

FIG. 1 is a plan view of an exemplary head disk assembly showing a first mode of operation (solid line) and a second mode of operation (dashed line), in accordance with the present invention.

FIG. 2 is a plan view of the first mode of operation as in FIG. 1, with a close up view including an exemplary crash stop drawn out from the plan view.

FIG. 3 is a perspective view of the head disk assembly of FIG. 2, with a close up view of the crash stop drawn out from the perspective view.

FIG. 4A is a perspective view of an exemplary crash stop in accordance with the present invention.

FIG. 4B is a side view of the crash stop of FIG. 4A.

FIG. 4C is a sectional view of the crash stop of FIG. 4B taken along line 4C.

FIG. 4D is a top view of the crash stop of FIG. 4A.

FIGS. 5A to 5D are perspective, side, sectional and top views, respectively, of an exemplary crash stop in accordance with the present invention, the crash stop including a skirt. FIG. 5C is a sectional view taken along line 5C of FIG. 5B.

FIGS. 6A to 6D are perspective, side, sectional and top views, respectively, of an exemplary crash stop in accordance with the present invention, the crash stop including an upward facing skirt and a downward facing skirt. FIG. 6C is a sectional view taken along line 6C if FIG. 6B.

FIGS. 7A to 7D are perspective, side, sectional and top views, respectively, of an exemplary crash stop in accordance with the present invention, the crash stop including an inwardly radiating flange. FIG. 7C is a sectional view taken along line 7C of FIG. 7B.

FIGS. 8A to 8D are perspective, side, sectional and top views, respectively, of an exemplary crash stop in accordance with the present invention, the crash stop including a segmented outwardly radiating flange. FIG. 8C is a sectional view taken along line 8C of FIG. 8B.

FIGS. 9A to 9C are perspective, side and top views, respectively, of an exemplary crash stop in accordance with the present invention, the crash stop including a plurality of flanges that spiral outwardly.

FIGS. 10A to 10C are sectional views of the crash stop of FIG. 4, further including a elastomeric insert in accordance with the present invention.

### DETAILED DESCRIPTION

Embodiments of the present invention will now be described with reference to the drawings, wherein like reference numerals are used to refer to like elements throughout. It will be understood that the figures are not necessarily to scale.

The present invention provides a crash stop to limit the actuator travel to locations only between the desired extents of travel. The crash stop decelerates the actuator quickly and in a short distance, but without damaging the actuator assembly.

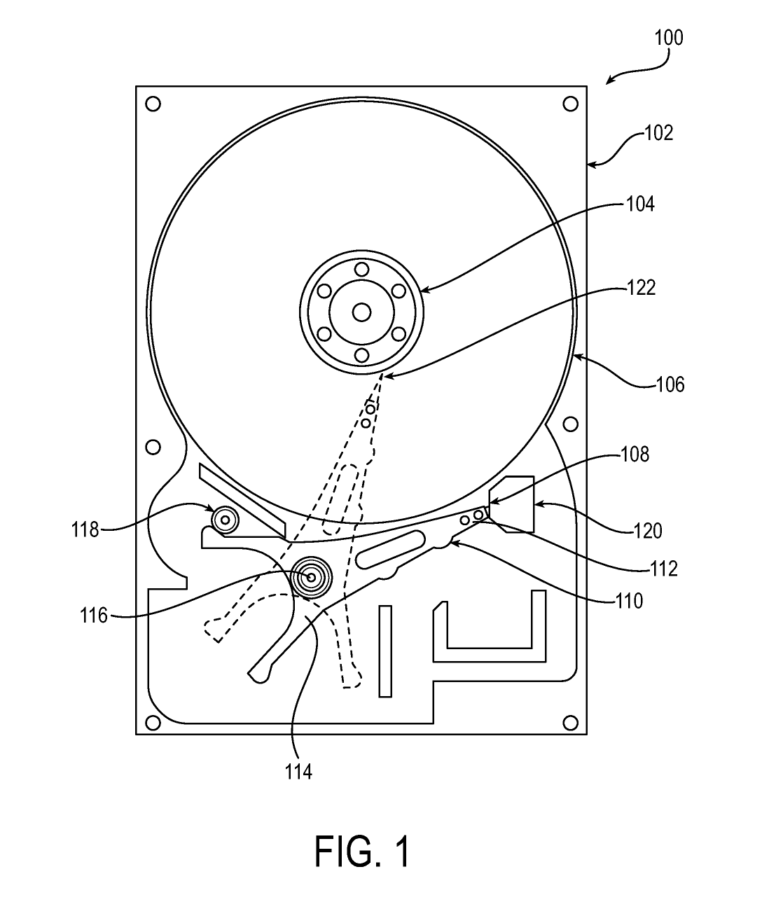

FIG. 1 depicts an exemplary head disk assembly 100 of a disk drive in accordance with embodiments of the present invention. Head disk assembly 100 includes chassis 102 to which various disk drive components are mounted. Head disk assembly includes at least one disk 106 that is rotated by a spindle motor 104. The disk drive also includes a head 108 that is located adjacent to a surface of the disk 106. While the disk 106 is being rotated, the head senses a magnetic field of the disk 106 or magnetizes the disk 106 to read or write information to/from the disk 106. In general, the head 108 is associated with the surface of the disk 106. Although one head 108 is illustrated in FIG. 1, it is understood that the head may include a writing head for magnetizing the disk 106 and a reading head for sensing the magnetic field of the disk 106. The reading head may include a magneto-resistive device, for example. The head 108 may be referred to as a transducer.

The head 108 may be mounted on a slider 110 that generates an air bearing between a surface of the head 108 and the surface of the disk 106. The slider 110 is integrated with a head gimbal assembly 112. The head gimbal assembly 112 is attached to an actuator arm 114 having a voice coil (not shown). A current supplied to the voice coil generates torque for rotating the actuator arm 114 with respect to a bearing assembly 116. Due to the rotation of the actuator arm 114, the head 108 is moved across the surface of the disk.

The head disk assembly 100 includes a crash stop system to limit the movable range of the head 108. The crash stop system may include an inner crash stop (not shown) for limiting movement of the head 108 in an inner periphery direction of the disk 106 to a maximum permitted location and an outer crash stop 118 for limiting movement of the head 108 in an outer periphery direction of the disk 106 to a maximum permitted location. Locations of the inner crash stop and the outer crash stop are determined so that the head 108 is guaranteed to move up to a certain location outside the data area of the disk 106.

When the head 108 reaches the maximum permitted location in the outer periphery direction of the disk 106, the actuator arm 114 attached to the head 108 contacts the outer crash stop 118. The head 108 is no longer able to move in the outer periphery direction of the disk 106. Similarly, when the head 108 reaches the maximum permitted location in the inner periphery direction of the disk 106, the actuator arm 114 attached to the head 108 contacts the inner crash stop. The head 108 is no longer able to move in the inner periphery direction of the disk 106.

In a loading mode of the disk drive, the head 108 is moved from a parking area located outside the data area of the disk 106 to the data area of the disk 106. In an unloading mode of the disk drive, the head 108 is moved from the data area of the disk 106 to the parking area located outside the data area of the disk 106.

The head disk assembly 100 may also include a ramp parking unit 120 for parking the head 108 outside the data area of the disk 106 in a power off mode or a power save mode of the disk drive. The ramp parking unit 120 is disposed in an outer periphery area outside the data area of the disk 106. In FIG. 1, the head gimbal assembly 112 shown in the solid lines indicates the unloading mode of the disk drive. The head gimbal assembly 112 shown in the dashed lines indicates the loading mode of the disk drive.

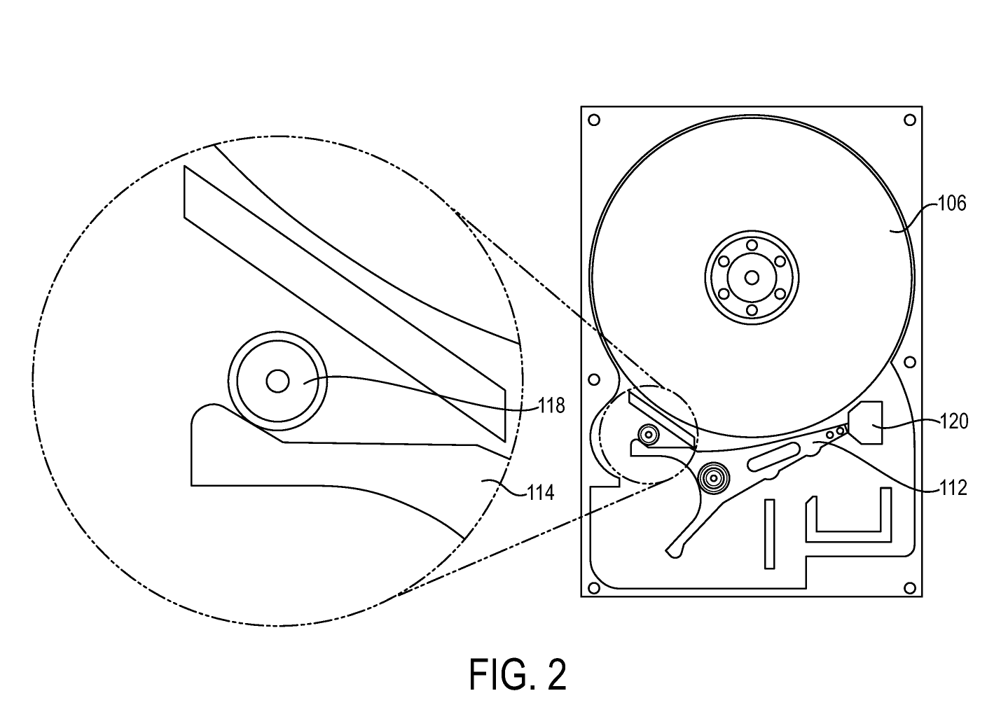

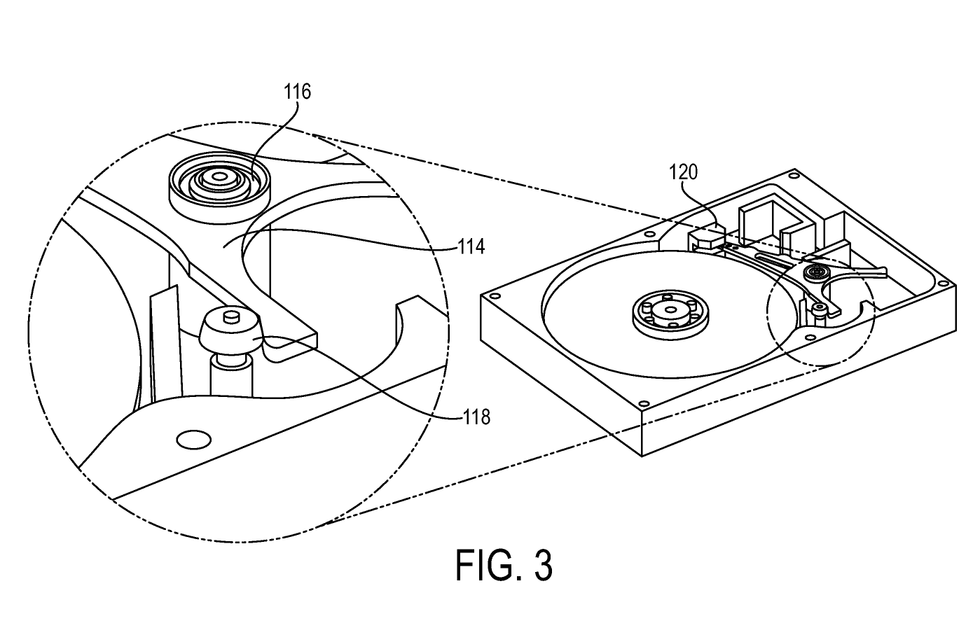

Referring to FIGS. 2 and 3, in the unloading mode, the head gimbal assembly 112, to which the head 108 is attached, moves in the direction from the data area of the disk 106 according to a rotation of the actuator arm 114 to contact a parking surface of the ramp parking unit 120. When the head gimbal assembly 112 is located on the parking surface of the ramp parking unit 120, the actuator arm 114 contacts the outer crash stop 118.

The crash stop 118 decelerates the head gimbal assembly 112 at a rate that will not damage the head 108 during a park or inner-diameter position event. Soft polymer materials can easily be designed to decelerate the head gimbal assembly at an acceptable rate. However, soft polymers are prone to problems relating to head gimbal assembly sticking or adhering to the crash stop. For example, a rubber pad or rubber coating to cushion the impact of the actuator arm upon the crash stop often causes stiction, which can hold the arm after impact, such that recovery of the arm's mobility is impaired. Soft polymers, such as fluoroelastomers (e.g., FKM rubbers) often require surface treatment to reduce adhesion problems. The surface treatment is process dependent and has a high probability of variance in its characteristics due to process variations. Hard polymers are not prone to such adhesion related problems, however, they are not generally used due to their stiff mechanical properties. High deceleration G-levels associated with hard polymers can damage the read/write heads.

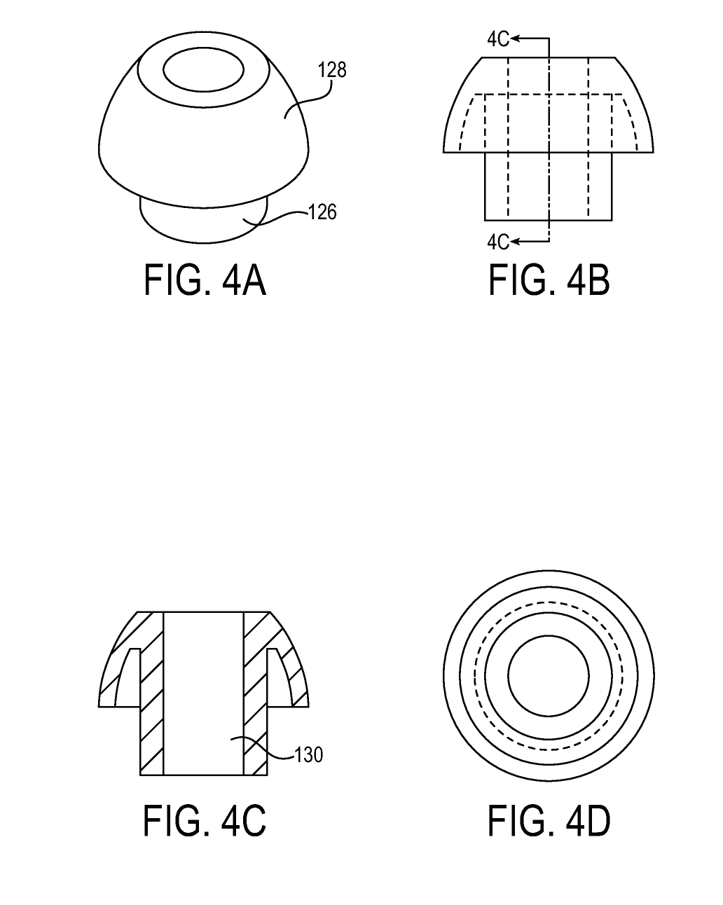

Referring to FIGS. 4A to 4D, an exemplary crash stop of the present invention is illustrated. Crash stop 118 includes a support body 126 having a cylindrical form, and a cantilever element 128 joined at a proximal portion to an end of the support body 126. In this embodiment, the cantilever element 128 includes a skirt attached to the outer surface of the support body. The support body terminates at its opposing end below the hem, i.e., distal portion, of the attached skirt. The support body 126 includes an inner axial bore 130 for receiving a fastener to attaching the crash stop 118 to the chassis 102.

The cantilever configuration of the umbrella-like, or mushroom-like shape provides a suitable force-displacement profile and deceleration rate necessary when using hard elastomeric polymeric materials, similar to that of soft elastomeric materials. For example, the cantilever configuration may be used with polymeric materials having durometer values higher than 60 on the Shore A scale. In one embodiment, the crash stop is made of a polyurethane material.

The support body and the cantilever element may form a unitary structure. In one embodiment, the support body and cantilever element are unitarily formed, such as by molding a polymeric material.

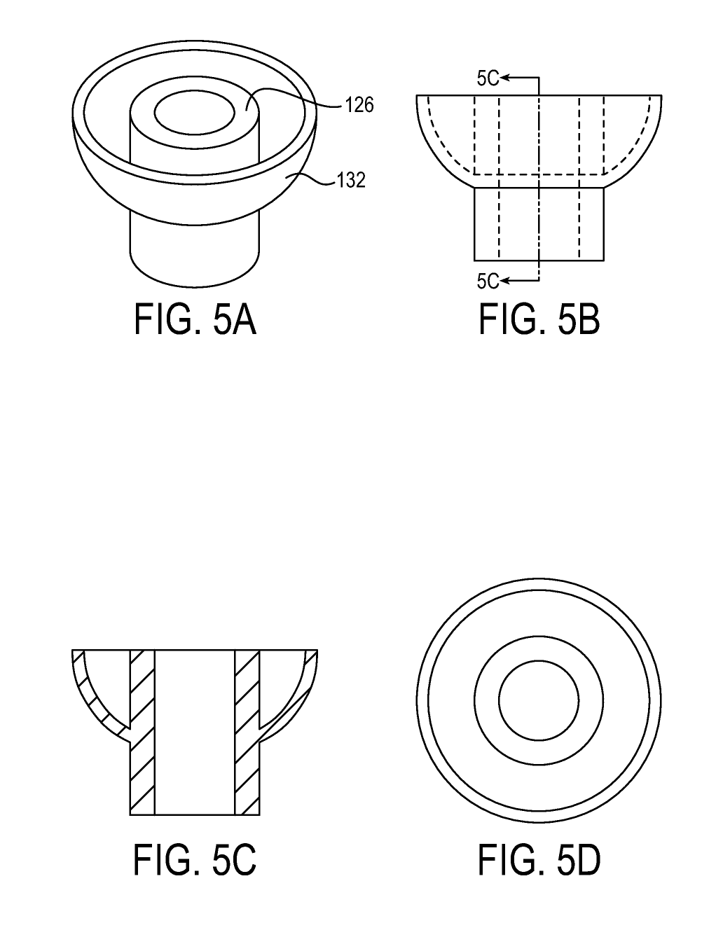

FIGS. 5A to 5D depict an embodiment of the crash stop of the present invention wherein the cantilevered element includes an external skirt 132 joined at a central portion of the outer surface of the support body 126, such that the support body terminates at the hem, or proximal portion of the skirt.

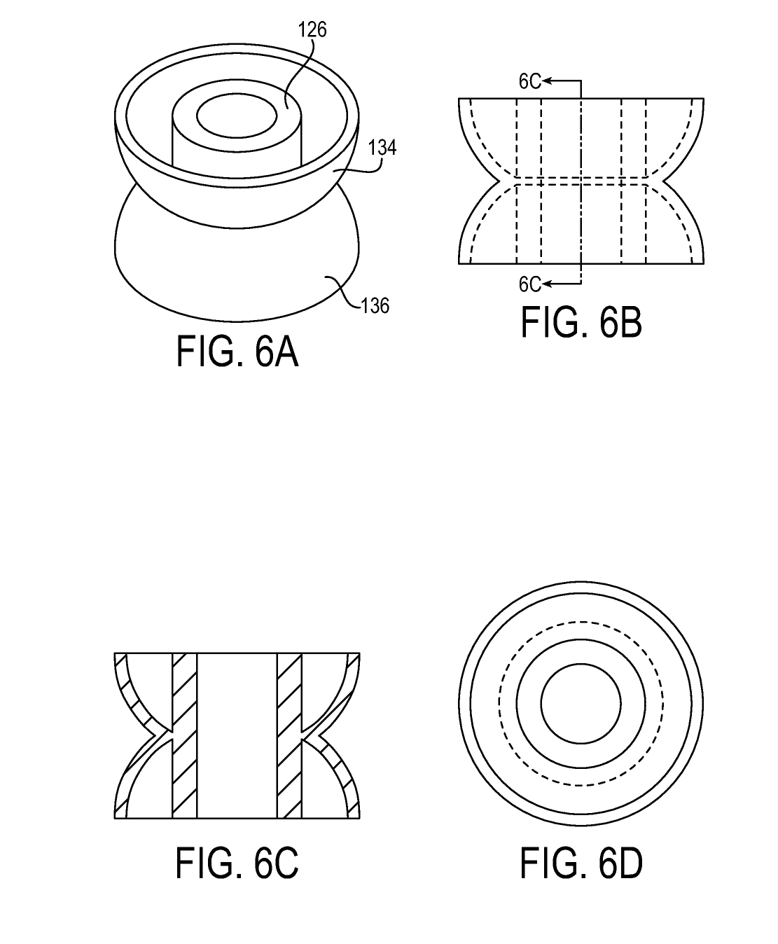

FIGS. 6A to 6D depict an embodiment of the crash stop of the present invention wherein the cantilevered element includes an upwardly facing first skirt 134 and a downwardly facing second skirt 136. The first external skirt is joined to the support body 126 at a central portion of the outer surface of the support body and terminates at a first end of the support body. The second external skirt 136 is joined to the support body 126 at a central portion of the outer surface of the support body and terminates at the opposing end of the support body.

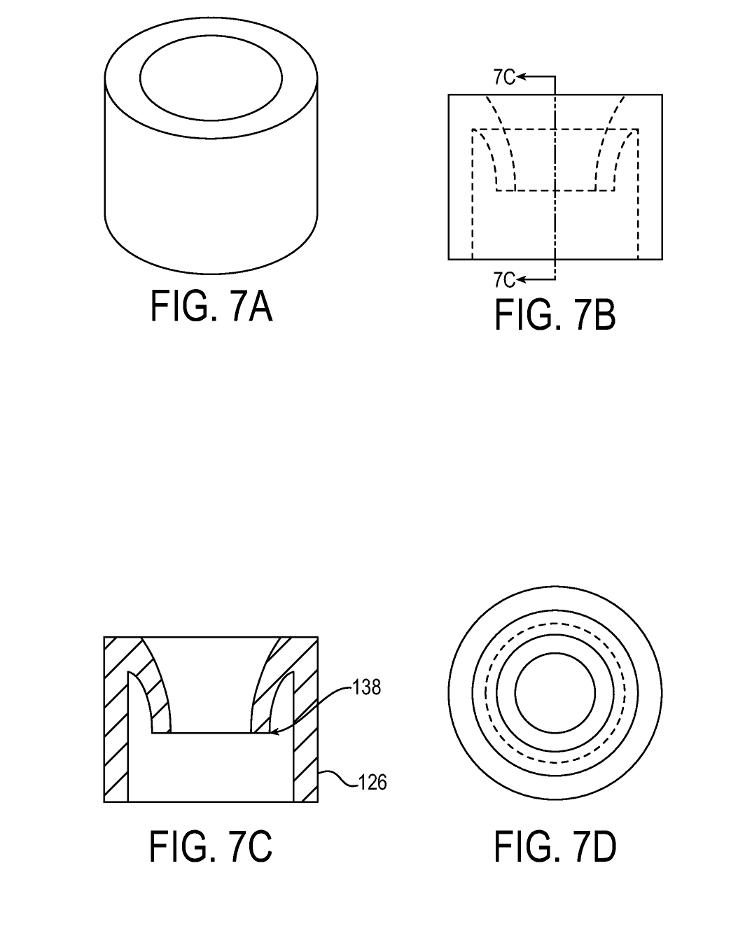

FIGS. 7A to 7D depict an embodiment of the crash stop of the present invention wherein the cantilevered element includes an inner flange 138. The inner flange 138 is joined at a proximate portion to an inner surface of the support body 126 and radiates inwardly toward the central axis of the support body.

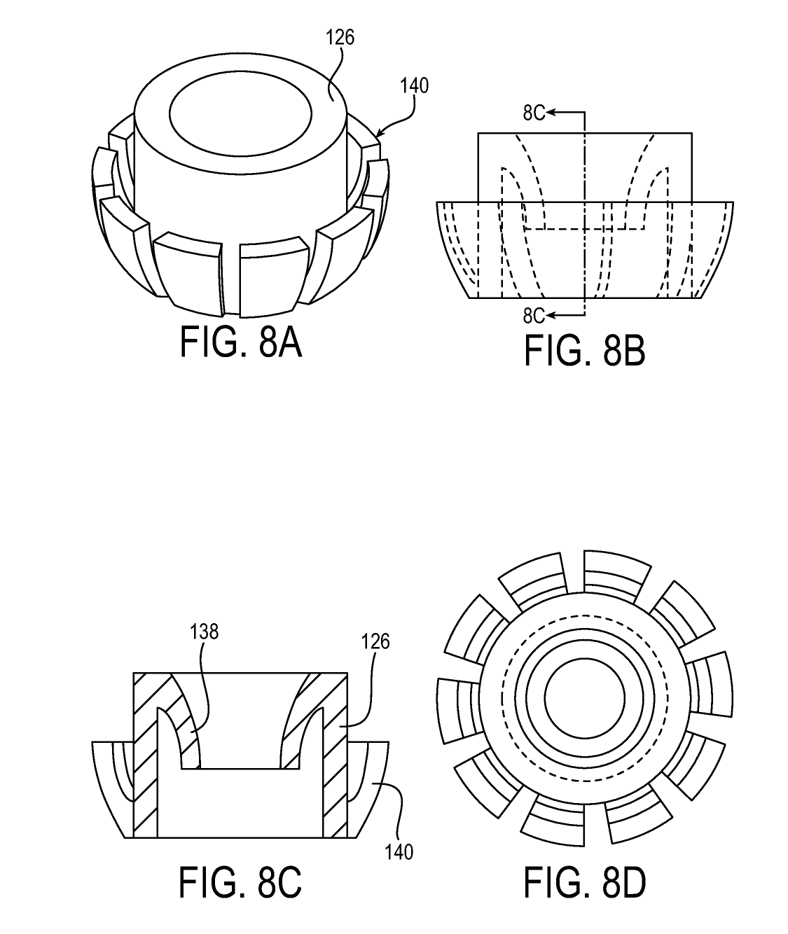

FIGS. 8A to 8D depict an embodiment of the crash stop of the present invention wherein the cantilevered element includes a first inner flange 138 as shown in FIGS. 7A to 7D, and further includes a second outer flange 140 that is segmented and radiates outwardly from the support body 126.

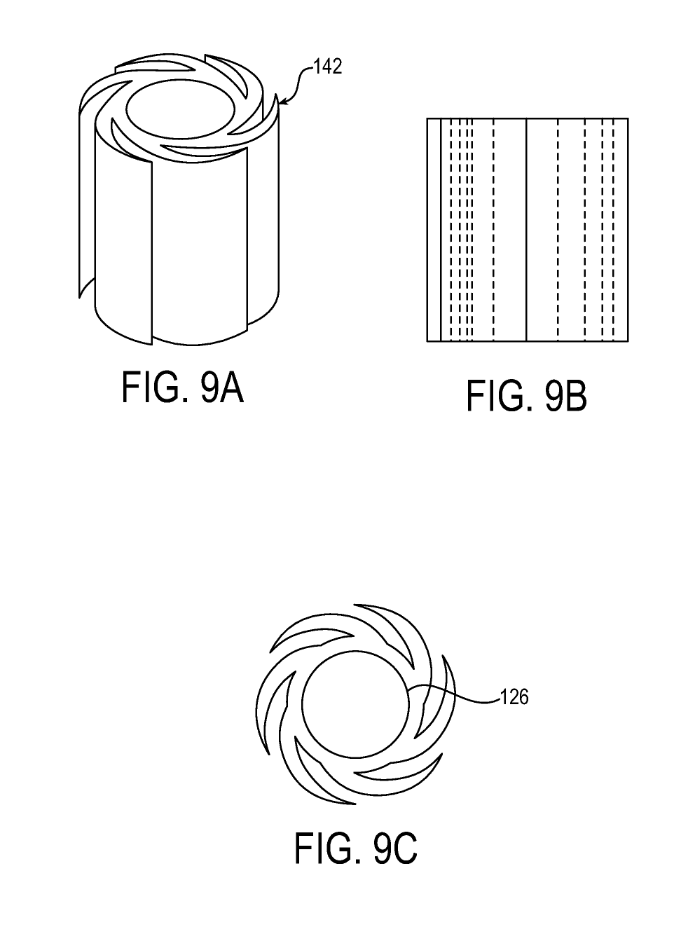

FIGS. 9A to 9C depict an embodiment of the crash stop of the present invention wherein the cantilevered element includes a plurality of flanges 142 that spiral outwardly from the support body 126 and overlap an adjacent flange.

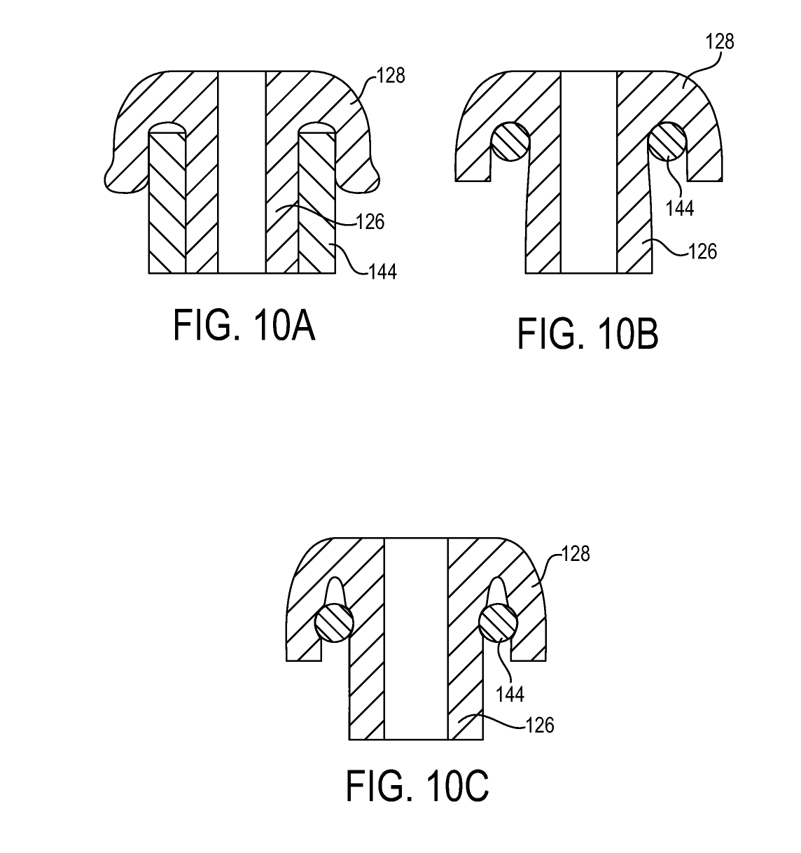

FIGS. 10A, 10B and 10C depict embodiments of the crash stop of the present invention that include a resilient member 144 interposed between the support body 126 and the cantilever element 128. In FIG. 10A, the resilient member 144 includes an elastomeric insert adjacent the length of the outer surface of the support body 126. The elastomeric insert may, for example, be an extruded member. In FIG. 10B, the resilient member 144 includes an elastomeric O-ring positioned at the proximal portion of the cantilever element 128. In FIG. 10C, the resilient member 144 includes an elastomeric 0-ring positioned close to the distal portion of the cantilever element 128. The elastomeric insert is constructed of a polymeric material that is softer than the material from which the support body and cantilever element are constructed, and provides additional dampening properties to the crash stop. The elastomeric insert may be constructed of, for example, a silicone rubber, a butyl rubber, an FKM rubber, or other energy absorbing material.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A crash stop for an actuator arm of a hard disk drive, comprising:
a support body having a cylindrical form and a central axis; and
a cantilever element joined at a proximal portion to the support body and having a distal portion spaced apart from the support body to allow for deflection of the distal portion of the cantilever element or the support body relative to the other.

2. The crash stop of claim 1, wherein the cantilever element comprises a skirt.

3. The crash stop of claim 2, wherein the support body terminates at the proximate portion of the skirt.

4. The crash stop of claim 2, wherein the support body terminates at the distal portion of the skirt.

5. The crash stop of claim 1, wherein the cantilever element comprises a first upwardly facing skirt and a second downwardly facing skirt, a first end of the support body terminating at the distal portion of the first skirt and an opposing end of the support body terminating at the distal portion of the second skirt.

6. The crash stop of claim 1, wherein the cantilever element comprises a flange joined at a proximate portion to an inner surface of the support body and radiating inwardly toward central axis.

7. The crash stop of claim 1, wherein the cantilever element comprises a segmented flange joined at a proximate portion to an outer surface of the support body and radiating outwardly from the support body.

8. The crash stop of claim 6, wherein the flange is a first unitary flange, the crash stop further comprising a second segmented flange joined at a proximate portion to an outer surface of the support body and radiating outwardly from the support body.

9. The crash stop of claim 1, wherein the cantilever element comprises a plurality of flanges that spiral outwardly from the support body and overlap an adjacent flange.

10. The crash stop of claim 1, further comprising a central bore for receiving a fastener for attaching the crash stop to an external member.

11. The crash stop of claim 1, further comprising a resilient member interposed between the cantilever element and the central body.

12. The crash stop of claim 11, wherein the resilient member comprises an O-ring.

13. The crash stop of claim 1, wherein the support body and the cantilevered element form a unitary structure.

14. The crash stop of claim 13, wherein the unitary structure comprises a molded polymer.

15. The crash stop of claim 14, wherein the molded polymer comprises polyurethane.

16. The crash stop of claim 1, wherein the cantilever element intersects a path of movement of the actuator arm.

17. A hard disk drive comprising:
a disk with a data surface of concentric tracks;
a spindle motor for rotating the disk about an axis generally perpendicular to the disk;
a slider maintained in operative relationship with the data surface when the disk is rotating;
a transducer attached to the slider for reading data from and writing data to the data surface;
an actuator for moving the slider generally radially relative to the disk to allow the transducer to access the data tracks;
at least one crash stop for limiting movement of the actuator, the crash stop comprising:
a support body having a cylindrical form and a central axis; and
a cantilever element joined at a proximal portion to the support body and having a distal portion spaced apart from the support body to allow for deflection of the distal portion of the cantilever element or the support body relative to the other.
